(19) United States
(12) Patent Application Publication
(10) Pub. No.: US 2024/0200341 A1
(43) Pub. Date: Jun. 20, 2024

(54) A BLOCKAGE CLEARING SYSTEM FOR A MULTI-STORY BUILDING CHUTE SYSTEM

(71) Applicant: FENTIAN NOMINEES PTY LTD, Parramatta (AU)

(72) Inventor: Tian VAN RENSBURG, Parramatta (AU)

(21) Appl. No.: 18/556,996

(22) PCT Filed: Apr. 21, 2022
(86) PCT No.: PCT/AU2022/050364

§ 371 Date: Oct. 24, 2023

(30) Foreign Application Priority Data
Apr. 26, 2021 (AU) 2021901224

(51) Int. Cl. E04F 17/12; B08B 9/043

(52) U.S. Cl. CPC E04F 17/123; B08B 9/0436

(57) ABSTRACT

A blockage clearing system for a multi-story building chute system having a vertical chute spanning multiple floors of a building, refuse doors for each floor and a lower exit, has a controller, a drive motor operably coupled to the controller, a blockage release mechanism driven by the drive motor to travel along an interior of the chute and a detector subsystem which detects an object blocked within the chute. The controller is programmed for retaining the blockage release mechanism in a home position above the refuse doors by default and, when receiving an input from the detector subsystem indicating an object blocked within the chute, operating the drive motor to cause the blockage release mechanism to travel down the chute to force the object down the chute.

### FIELD OF THE INVENTION

This invention relates generally to a blockage clearing system for a multi-story building chute system.

### BACKGROUND OF THE INVENTION

A multi-story building refuse chute system may comprise a vertical chute spanning multiple floors. The chute system comprises a plurality of refuse doors at each floor and a lower exit. Users of each floor may open their respective door to deposit refuse therein which falls down the chute to collection bins thereunderneath.

The chute oftentimes however becomes blocked which requires manual clearing.

The present invention seeks to provide a way which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a blockage clearing system for a multi-story building chute system. The blockage clearing system comprises a controller, a drive motor operably coupled to the controller and the blockage release mechanism driven by the drive motor to travel along an interior of the chute. The blockage release mechanism may comprise a ram plate driven by a pulley system.

The system further comprises a detector subsystem which detects an object blocked within the chute.

As such, in use, the controller is programmed for retaining the blockage release mechanism in a home position above the refuse doors by default and, when receiving an input from the detector system indicating an object blocked within the chute, operating the drive motor to cause the blockage release mechanism to travel down the chute to force the object down the chute.

The system further comprises various sensors and modes of operation to detect and deal with various fault conditions.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a blockage clearing system installed within a multi-storey building chute system in accordance with an embodiment; and

FIG. 2 shows a control system schematic of the blockage clearing system in accordance with an embodiment.

### DESCRIPTION OF EMBODIMENTS

A chute system comprises a vertical chute 101 spanning multiple floors. The chute 101 is typically rectangular cross-section and metallic. The chute system further comprises refuse doors 102 at each floor and a lower exit 103 from which refuse falls into awaiting collection bins. In use, users on each floor can open a respective door 102 to deposit refuse therein which falls under gravity down the chute 101 from the exit 103.

A blockage clearing system 100 comprises a controller 104 and a drive motor 105 operably coupled to the controller 104.

The system 100 further comprises a blockage release mechanism driven by the drive motor 105 which travels within the chute 101.

The controller 104 comprises a processor 106 for processing digital data. A memory device 107 storing digital data including computer program code instructions is operably coupled to the processor 106 via a system bus 108. These computer program code instructions may be logically divided into a plurality of computer program code instruction controllers 109. In use, the processor 106 fetches these computer program code instruction controllers and associated data 110 for implementing the control functionality described herein.

The controller 104 may take the form of a programmable logic controller (PLC) device.

Alternatively, the controller 104 may form part of a HMI/SCADA control system architecture which uses networked data to provide a graphical user interface 126 to allow operators to monitor the system 100 and issue process commands and settings.

The controller 104 comprises an I/O interface 111 for interfacing with the various peripherals described herein.

The system 100 further comprises a detector subsystem which detects an object 112 blocked within the chute 101. In use, the controller 104 is programmed for receiving an input from the detector subsystem indicating the blockage of the object 112 within the chute 101 and operating the drive motor 105 to cause the blockage release mechanism to travel down the chute to force the object 102 down the chute 101 and from the exit 103 thereof.

The blockage release mechanism may be retained in a home position by the controller 104 above the doors 102 by the controller 104 by default to thereby allow unobstructed use of the chute 101 in the normal manner.

A motor controller 113 may interface the controller 104 to control the drive motor 105. The motor controller 113 may be a variable-frequency drive (VFD).

The system 100 may comprise a pressure sensor to determine pressure applied by the blockage release mechanism. In embodiments, the pressure sensor comprises the motor controller 113 comprising a torque sensor operably coupled to a driveshaft of the drive motor 105. Readings from the torque sensor may be used to detect pressure overload faults of the blockage release mechanism.

The motor controller 113 may further comprise a revolution counter operably coupled to a driveshaft of the drive motor 105. The controller 104 may determine the position of the blockage release mechanism within the chute 101 by receiving a revolution count from the revolution counter or by counting revolutions from the revolution counter.

The system 100 may comprise a top position sensor 114 at a top end of the chute 101 for detecting a position of the blockage release mechanism. In use, the controller 104 may be programmed to bring the blockage release mechanism to the top of the chute 101 until receiving a reading from the top position sensor 114.

Furthermore, the system 100 may comprise a bottom position sensor 115 for detecting a bottom travel limit position of the blockage release mechanism. Similarly, in use, the controller 104 may be programmed to drive the blockage release mechanism down the chute 101 until receiving a signal from the bottom position sensor 115. The sensors 114, 115 may be mechanical contacts switches, light beam interrupt switches, field effect proximity sensors and/or the like.

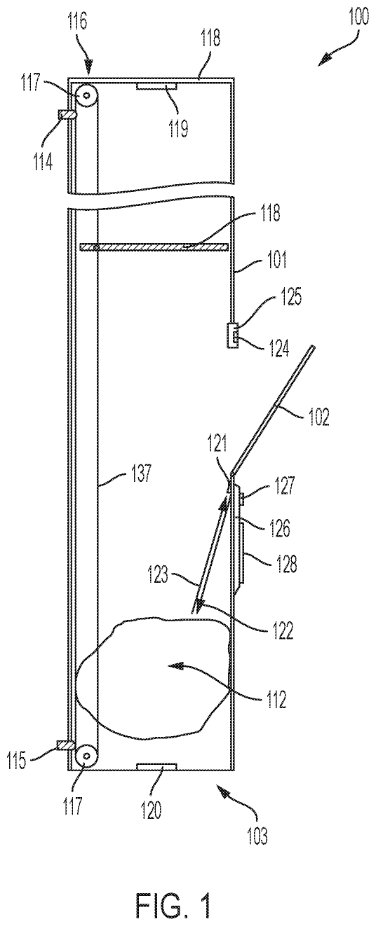

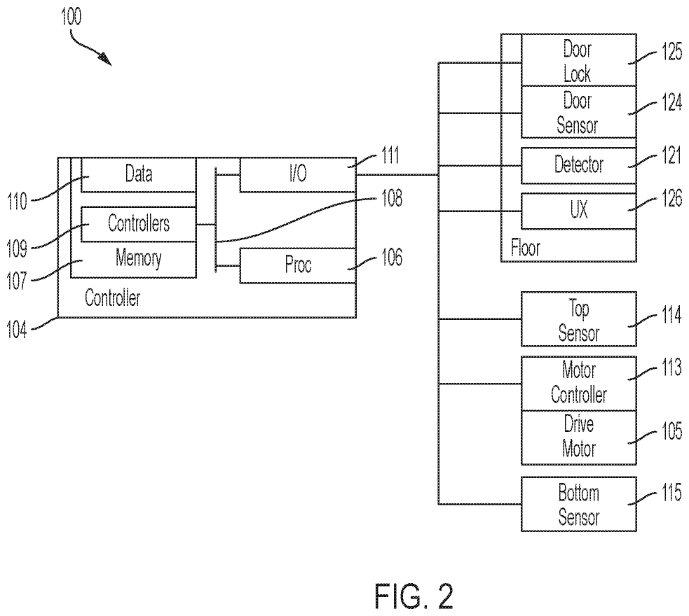

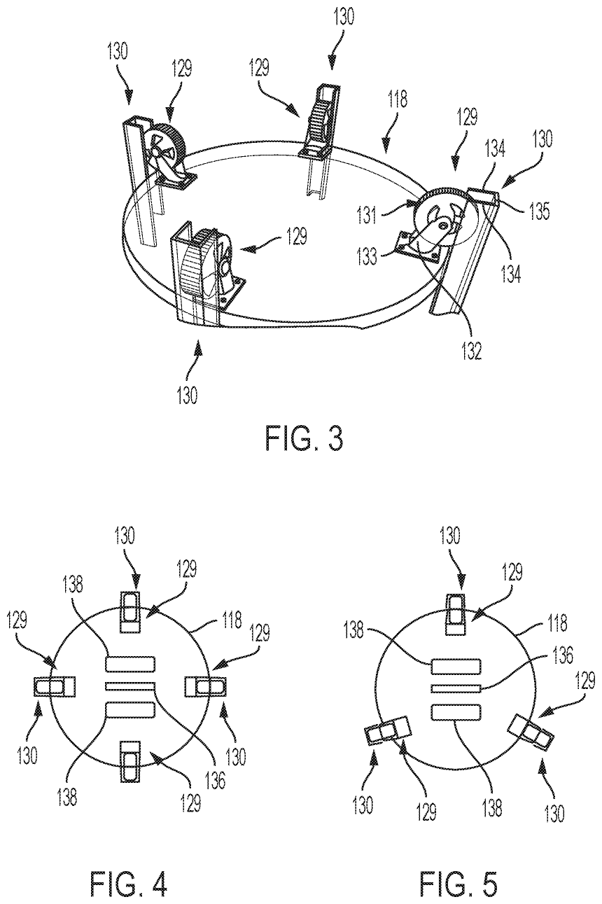

In the embodiment shown in FIG. 1, the blockage release mechanism 100 comprises a pulley system 116 comprising at least top and bottom pulleys 117 and a drive belt thereabout which acts on a ram plate 118 to thereby cause the ram plate 118 to travel within the chute 101. The ram plate 118 may comprise a cross-section fitting within the cross-section of the chute 101, and, in a preferred embodiment, conforming substantially with an inner cross-section of the chute 101. In the embodiment shown, a single drive belt is shown but, in embodiments, multiple drive belts may act on opposite sides of the ram plate 118.

The pulley system 116 may allow the ram plate 118 to travel substantive lengths, such as for high-rise buildings. Furthermore, the pulley system 116 does not occupy substantive space within the chute 101 and allows the home position of the ram plate 118 to be quite close to the roof 118 of the chute 101.

At least one of the pulleys 117 is driven by the drive motor 105. In embodiments, the system 100 comprises two drive motors 105 acting on the upper and lower pulleys 117 respectively.

The system 100 may comprise a top stopper 119 to physically arrest the upper travel limit of the ram plate 118. Similarly, the system 100 may comprise a bottom stopper 122 physically arrest the lower travel limit of the ram plate 118. The stoppers 119, 120 may be just beyond each respective position sensor 114, 115 so as to only physically arrest the travel of the ram plate 118 upon failure of the associated sensor 114, 115.

In the embodiment shown, the detection system comprises a plurality of reflection sensors 121. Each reflection sensor 121 may emit a beam of light 122 down the chute 101 and receive a reflection 123 from a blocked object 112 to detect the blocked object 112. The chute 101 may comprise a plurality of these reflection sensors 121 along the length thereof and wherein the operative range of each is sufficient to reach the next adjacent reflection sensor 101 so as to avoid any visibility dead spots within the chute 101. The reflection sensor 121 may emit pulsed light and comprise a phase locked receiver to increase the sensitivity of the reflection sensor 121.

In alternative embodiments, other types of detection systems may be utilised. For example, each door 121 may comprise a light beam interrupt thereacross to detect the insertion of an object 112 therein and the system 100 may further comprise a further light beam interrupt across the exit 103. As such, should the controller 104 receive a signal from a door light beam interrupt and not from the exit interrupt, the controller 104 may determine that an object 112 is blocked within the chute 101.

The detection system may further comprise ultrasonic sensors which detect blockages by the reflection of sound waves therefrom.

The system 100 may comprise a door sensor 124 to detect whether the door 102 is open or closed.

The system 100 may further comprise a door lock 125 to lock the door 102 closed. In embodiments, the door lock 125 comprises a magnetic block comprising an integral door sensor 124.

The system 100 may further comprise a user interface 126. As shown in FIG. 1, the system 100 may comprise a user interface 126 located on each floor for use by users on each floor.

The user interface 126 may comprise indicators 127, such as red and green indicator lights. The user interface 126 may further comprise a digital display 128 for the display of digital information thereon. The digital display 128 may comprise a haptic overlay so as to receive user input gestures in relation to information displayed thereon.

The user interface 126 may indicate an operational status of the system 100, such as normal operation, detection of a blockage and a fault condition. The user interface 126 may display a position of a detected blockage. Furthermore, the user interface may display a position of the blockage release mechanism.

The user interface 126 may be controlled to activate the blockage release mechanism and/or clear a fault.

In embodiments, a user interface 126 may be centrally located within a building control room or the like for performing some or all of these functions.

During initialisation of the system 100, the controller 101 may firstly detect whether the blockage release mechanism is at the home position. In this regard, the controller 104 may reference the revolution counter of the motor controller 113 or the top position sensor 114. The controller 104 determines that the blockage release mechanism is not the home position, the controller 104 may control the drive motor 105 to return the blockage release mechanism to the home position. As alluded to above, where the blockage release mechanism comprises the ram plate 118, the controller 104 may drive the drive motor 105 until the position of the ram plate 116 is detected by the top position sensor 114.

Once at the home position, the user interface 126 may indicate normal operation of the system 100 wherein users can open their respective doors 102 to deposit refuse therein.

If an object 112 becomes blocked within the chute 101, the controller 104 receives a signal from the detector 121. As such, the controller 104 is configured to free the chute 101.

Prior operating the blockage release mechanism, the controller 104 may reference the door sensors 104 to ensure that all doors 102 are closed.

If all doors 102 are closed, the controller 104 may lock all of the doors 102 using the door locks 125.

Then, the controller 104 may control the drive motor 105 to operate the blockage release mechanism. Where the blockage release mechanism comprises the ram plate 118, the controller 104 may control the drive motor 105 to cause the ram plate 118 to travel down the chute 101 to the bottom of the chute 101. As alluded to above, the controller 104 may detect the end of range travel position of the ram plate 118 by counting revolutions from the motor controller 113 and/or by receiving a signal from the bottom position sensor 115.

Once at the end of range position, the controller 104 may reverse the drive motor 105 to bring the ram plate 108 back up to the home position ready for next use. As alluded to above, where the blockage release mechanism comprises the ram plate 118, the controller 104 may detect the home position of the ram plate 118 by referencing a count of the revolution counter of the motor controller 113 and/or by receiving a signal from the top position sensor 114.

If the controller 104 receives a signal from a door sensor 104 indicative of a door 102 being opened at any time during the operation of the drive motor 105, the controller 104 may detect a door open fault condition and immediately cease operation of the drive motor until the door 102 is closed again. The controller 104 may display an error message and or output an error sound using the user interface 126 associated with the detected open door 102.

During operation of the drive motor 105, the controller 104 may monitor for torque overload indicative of excessive pressure being applied on the ram plate 118. If excessive pressure is detected, the controller 104 may enter a pressure overload fault state.

For a fault state, the controller 104 may be programmed to automatically attempt to resolve the fault or alternatively wait for user intervention.

When detecting a pressure overload fault, the controller 104 may return the ram plate 118 to the home position prior reattempting a further dislodgement. If the further dislodgement fails, the controller 104 may halt operation awaiting manual intervention wherein a maintenance user may inspect the chute 101 to resolve the mechanical issue and then clear the fault using the user interface 126.

In embodiments, the controller 104 may detect a position loss faults wherein the drive motor 105 is operated but the position of the blockage release mechanism is not detected by the top position sensor 114 or the bottom position sensor 115.

For example, when driving the blockage release mechanism down the chute 101, the controller 104 may reference a count of a revolution counter of the motor controller 113 and/or set a timer to time the expected travel time of the blockage release mechanism down the chute 101. If a signal is not received by the bottom position sensor 114 when expected, such as at a certain revolution count and/or after a certain time, the controller 104 may enter a bottom position loss fault state.

For a bottom position loss fault state, the controller 104 may either await manual intervention or alternatively return the blockage release mechanism to the top of the chute 101 but suspend further operation thereof until a manual override is received.

FIG. 3-5 show one embodiment of the ram plate 118 of the blockage release mechanism.

In the embodiment shown, the ram plate 118 is generally circular (preferably to conformably fit a correspondingly circular chute 101) although other cross sections are possible depending on the particular application.

The ram plate 118 comprises guide wheel assemblies 129 located at a periphery of the ram plate 118 to engage respective guide channels 130. The guide channels 130 may run substantially the entire length of the chute 101 so that the guide wheel assemblies 129 may guide the ram plate 110 across the multiple floors of the building.

In the embodiment shown in FIG. 3 and FIG. 4, the ram plate 118 is guided by a quadrant of guide wheel assemblies at 90° apart however other embodiments are envisaged, including wherein the ram plate 118 is guided by three guide wheel assemblies 129 at 120° apart as is shown in FIG. 5, or other number of guide wheel assemblies 129, including two or more than four.

Each guide wheel assembly 129 may comprise a wheel 131 supported from the ram plate 118 by a bracket 132. The bracket 132 may be fastened to a surface of the ram plate 118 and extended an angle therefrom so that the wheel 129 extends across the edge of the ram plate 118, thereby maximising the surface area of the ram plate 118, allowing the edges of the ram plate 118 to go against the guide rails 130 and protecting the guide wheel assemblies 129.

In the embodiment shown in FIG. 3, the brackets 132 are attached to an upper surface of the ram plate 118. Also, in the embodiment shown, the bracket 132 may be forked so as to engage either side of an axle of the wheel 129. Furthermore, the bracket 122 may be swivel mounted from the ram plate 118 by a swivel 133 which may assist in the installation and stability of the ram plate 118.

The guide channel 130 may take the form of a C-channel having side flanges 134 and a central orthogonal web 135 therebetween, thereby forming a channel within which the wheel 131 runs along a length thereof. The side flanges 134 engage either side of the wheel 131 to hold the wheel 131 straight as an edge of the wheel 131 roles against the web 135.

As shown in FIG. 4, the ram plate 118 may comprise a drive belt engagement 136 to engage the drive belt 137. In the embodiment shown, the drive belt engagement 136 is centrally located within the ram plate 118 so that the ram plate 118 is balanced with respect to the drive belt engagement 136. However, as alluded to above, in embodiments, more than one drive belt 137 may engage edges of the plate 118.

The ram plate 118, guide rails 130 and associated componentry may be precision laser cut to enhance balance and therefore stability as the ram plate 118 traverses the chute 101.

FIG. 4 further shows wherein the ram plate 118 supports locking actuators 138 which may lock the ram plate 118 with respect to the guide rails 130 to prevent freefall of the ram plate 118 in the event of a system fault or malfunction.

In embodiments, the locking actuators may extend locking pins into the guide rails 130 or alternatively frictionally act on the wheels 131 of the wheel assemblies 129. The locking actuators 138 may respond to a fault condition signal from the controller 104. In alternative embodiments, the locking actuators 138 may comprise accelerometers and wherein the locking actuators 138 respond to acceleration exceeding a threshold (such as 0.7 G) indicative of freefall of the ram plate 118.

In embodiments, a pulley attachment frame (not shown) may be provided to suspend the upper pulley 117 at the top of the chute 101. The pulley attachment frame may be cross-shaped in having a pair of orthogonally joined arms, the distal ends of which engage the chute 101 and which define a central point from which a central pulley 117 may be suspended. In alternative embodiments, the pulley attachment frame may suspend a number of pulleys 117 where more than one drive belt 137 is employed.

Whereas the system is described herein may be particularly applicable for refuse chute systems, the present system may be applicable for other types of multistory chute systems which may become periodically blocked, including laundry chute systems and the like.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A blockage clearing system for a multi-story building chute system, the chute system comprising a vertical chute spanning multiple floors of a building, refuse doors for each floor and a lower exit, wherein the blockage clearing system comprises:
a controller;
a drive motor operably coupled to the controller;
a blockage release mechanism driven by the drive motor to travel along an interior of the chute;
a detector subsystem which detects an object blocked within the chute; and wherein, in use, the controller is programmed for retaining the blockage release mechanism in a home position above the refuse doors by default and, when receiving an input from the detector subsystem indicating an object blocked within the chute,
operating the drive motor to cause the blockage release mechanism to travel down the chute to force the object down the chute.

2. The system as claimed in claim 1, wherein the system comprises a pressure sensor to determine pressure applied by the blockage release mechanism.

3. The system as claimed in claim 2, wherein the pressure sensor comprises a torque sensor operably coupled to a driveshaft of the drive motor.

4. The system as claimed in claim 2, wherein, in use, the controller is programmed for detecting and overpressure fault if pressure detected by the pressure sensor exceeds a threshold.

5. The system as claimed in claim 4, wherein the controller is further programmed for awaiting a manual override to clear the overpressure fault.

6. The system as claimed in claim 4, wherein the controller is further programmed for returning the blockage release mechanism to the home position when detecting the overpressure fault.

7. The system as claimed in claim 6, wherein the controller is further configured for suspending further operation of the blockage release mechanism until the overpressure fault is cleared.

8. The system as claimed in claim 1, wherein the system further comprises a revolution counter operably coupled to a driveshaft of the drive motor and wherein the controller is programmed to receive revolution counts therefrom to determine a position of the blockage release mechanism.

9. The system as claimed in claim 8, wherein the system further comprises a position sensor to detect the position of the blockage release mechanism within the chute and wherein the controller is configured for detecting a position loss fault depending on a count from the revolution counter if a signal is not received from the position sensor.

10. The system as claimed in claim 9, wherein the position sensor is a lower position sensor and wherein the controller is programmed for returning the blockage release mechanism to the home position when detecting the position loss fault.

11. The system as claimed in claim 1, wherein the system comprises a top position sensor at a top end of the chute configured for detecting the position of the blockage release mechanism and wherein the controller is configured for bringing the blockage release mechanism up the chute until receiving a signal from the top position sensor.

12. The system as claimed in claim 1, wherein the system comprises a bottom position sensor at a bottom end of the chute configured for detecting the position of the blockage release mechanism and wherein the controller is configured for driving the blockage release mechanism down the chute until receiving a signal from the bottom position sensor.

13. The system as claimed in claim 1, wherein the detector subsystem comprises at least one reflection sensor configured to detect a blockage when receiving a reflection from the object blocked within the chute.

14. The system as claimed in claim 13, wherein the system comprises a plurality of reflection sensors along the length of the chute, each having an operative range to reach the next adjacent reflection sensor.

15. The system as claimed in claim 14, wherein the reflection sensor emits pulsed light and comprise a phase locked receiver.

16. The system as claimed in claim 1, wherein the blockage release mechanism comprises a pulley mechanism having a drive belt driving a ram plate.

17. The system as claimed in claim 16, wherein the drive belt comprises at least one of a metal cable and a chain.

18. The system as claimed in claim 16, wherein the pulley mechanism comprises at least a top pulley and a bottom pulley, at least one thereof driven by the drive motor.

19. The system as claimed in claim 16, wherein the system comprises two drive motors for each of a top pulley and a bottom pulley of the pulley mechanism.

20. The system as claimed in claim 16, wherein the pulley mechanism comprises more than one drive belt operative on different sides of the ram plate.

21. The system as claimed in claim 1, further comprising door sensors for each door configured for detecting whether each door is open or closed.

22. The system as claimed in claim 21, wherein prior operating the drive motor, the controller is configured for determining that all doors are closed.

23. The system as claimed in claim 22, wherein if, during operation of the drive motor, the controller receives a signal from at least one door sensor indicative that at least one door has been opened, the controller is programmed for ceasing operation of the drive motor.

24. The system as claimed in claim 23, wherein the controller is programmed for resuming operation of the drive motor when subsequently determining that the at least one door has been closed.

25. The system as claimed in claim 1, further comprising door locks for each door and wherein, prior operation of the drive motor, the controller is configured for locking all doors.

26. The system as claimed in claim 25, wherein the door locks comprise a magnetic lock.

27. The system as claimed in claim 1, further comprising a user interface.

28. The system as claimed in claim 27, wherein the user interface comprises a user interface adjacent each door.

29. The system as claimed in claim 27, wherein the user interface is operative to indicate an operational state of the system including at least one of normal operation, blockage detection and a fault condition.

30. The system as claimed in claim 27, wherein the user interface is operative to display a position of a detected blockage.

31. The system as claimed in claim 27, wherein the user interface is operative to display a position of the dockage release mechanism.

32. The system as claimed in claim 27, wherein the user interface comprises an input to operate the blockage release mechanism.

33. The system as claimed in claim 27, wherein the user interface comprises an input to clear a fault condition.

34. The system as claimed in claim 1, wherein the blockage release mechanism comprises a ram plate which traverses an interior of the chute.

35. The system as claimed in claim 34, wherein the ram plate is circular in cross-section.

36. The system as claimed in claim 34, wherein the ram plate is guided by a periphery of guide wheel assemblies.

37. The system as claimed in claim 36, wherein the guide wheel assemblies are guided within respective guide channels.

38. The system as claimed in claim 37, wherein each channel comprises lateral flanges and a central web and wherein the lateral flanges bear against sides of a wheel of a respective wheel assembly as the wheel rolls against the web.

39. The system as claimed in claim 36, wherein each guide wheel assembly comprises a bracket affixing a wheel to the ram plate.

40. The system as claimed in claim 29, wherein each bracket is attached to a surface of the ram plate so that a respective wheel extends across an edge of the ram plate.

41. The system as claimed in claim 36, wherein the ram plate is supported by a quadrant of guide wheel assemblies.

42. The system as claimed in claim 36, wherein the ram plate is supported by three guide wheel assemblies.

43. The system as claimed in claim 34, wherein the ram plate comprises a belt engagement for a drive belt.

44. The system as claimed in claim 43, wherein the belt engagement is centrally located.

45. The system as claimed in claim 34, wherein the ram plate supports locking actuators operative to lock the ram plate with respect to the chute.

46. The system as claimed in claim 45, wherein the locking actuators extend locking pins into guide rails.

47. The system as claimed in claim 45, wherein the locking actuators frictionally engage wheels of guide wheel assemblies guiding the ram plate.

48. The system as claimed in claim 45, wherein the locking actuators operate responsive to a fault condition signal from the controller.

49. The system as claimed in claim 45, wherein the locking actuators comprise an accelerometer and wherein the locking actuators operate responsive to the accelerometer detecting acceleration exceeding a threshold.

50. The system as claimed in claim 18, further comprising a pulley attachment frame to suspend the upper pulley

51. The system as claimed in claim 50, wherein the pulley attachment frame is cross-shaped in having a pair of orthogonally joined arms, the distal ends of which engage the chute and which define a central point from which a central pulley is suspended.
